(19) United States
(12) Patent Application Publication
(10) Pub. No.: US 2022/0376329 A1
(43) Pub. Date: Nov. 24, 2022

(54) BATTERY INSULATION STRUCTURE

(71) Applicant: SANKEI GIKEN KOGYO CO., LTD., Tokyo (JP)

(72) Inventors: Keisuke Nakamura, Isesaki-shi (JP); Ryuho Ikemasu, Isesaki-shi (JP)

(73) Assignee: SANKEI GIKEN KOGYO CO., LTD., Tokyo (JP)

(21) Appl. No.: 17/771,327

(22) PCT Filed: Sep. 25, 2020
(86) PCT No.: PCT/JP2020/036223

§ 371 Date: Apr. 22, 2022

(30) Foreign Application Priority Data
Nov. 25, 2019 (JP) 2019-212376

(51) Int. Cl. H01M 50/103; H01M 10/613; H01M 10/6568; H01M 10/625; H01M 50/131; H01M 50/15; H01M 50/124

(52) U.S. Cl. CPC H01M 50/103; H01M 10/613; H01M 10/6568; H01M 10/625; H01M 50/131; H01M 50/15; H01M 50/124; H01M 2220/20

(57) ABSTRACT

This battery insulation structure includes a double-walled insulating container 1 including an insulating container main body 2 in which an insulating space S1 is provided between an inner wall 21 and an outer wall 22, and an insulating lid 3 in which an insulating space S2 is provided between an inner lid 31 and an outer lid 32, and a battery body 4 housed in the insulating container 1, wherein the battery body 4 is arranged to be spaced apart from the inner wall 21 of the insulating container main body 2 and the inner lid 31 of the insulating lid 3. This battery insulation structure can be adapted to both a very low-temperature external environment and a very high-temperature external environment, and can reduce the influence of the temperature of the external environment on the batter as much as possible.

### TECHNICAL FIELD

The present invention relates to a battery insulation structure that suppresses a change in temperature of a battery of an electric vehicle or the like.

### BACKGROUND ART

Conventionally, Patent Literatures 1 and 2 disclose structures for suppressing a change in temperature of a battery and keeping the battery in an appropriate temperature range. The structure of Patent Literature 1 includes a heat storage body provided so as to cover a peripheral surface excluding an upper surface of a battery, a box-shaped insulating material, and a sheet-shaped electric heater interposed between an inner surface of the insulating material and an outer surface of the heat storage body. This structure can keep the battery warm even after the operation of the electric heater is completed, and can be adapted to cold weather or cold regions to prevent deterioration of the electromotive force of the battery and the startability of the engine.

The structure of Patent Literature 2 includes an insulating housing main body and an insulating lid provided so as to cover an entire plurality of battery cells constituting a battery, a latent heat storage material filled in the insulating housing main body and provided so as to cover the battery cells, a cooling water storage tank configured to store a cooling water of an engine, and an adsorption heat storage material reaction tank interposed between the cooling water storage tank and the latent heat storage material to store an adsorption heat storage material that generates adsorption heat by adsorbing water. This structure can quickly raise the temperature of the battery even when the battery is in a low charge state.

### CITATION LIST

### Patent Literature

[PTL 1] Japanese Patent Application Publication No. H10-32021

[PTL 2] Japanese Patent Application Publication No. 2017-216097

### SUMMARY OF INVENTION

### Technical Problem

By the way, although the battery structures of Patent Literatures 1 and 2 can prevent a decrease in output voltage and a decrease in discharge capacity to obtain satisfactory battery performance in a low-temperature external environment due to cold weather or cold regions, good battery performance can be obtained. However, the structures cannot prevent permanent deterioration of battery performance in a high-temperature external environment due to hot weather or tropical regions. That is, when the high temperature state of the battery is maintained, the battery will be significantly deteriorated and the battery life may be shortened. However, in an extremely high-temperature external environment, providing the simple insulating housing main body and the insulating lid of Patent Literature 2, for example, is not enough for preventing the battery from becoming too hot. Therefore, there is a demand for a structure that can reduce the influence of the temperature of the external environment on the battery as much as possible in both an extremely low-temperature outside hearing environment and an extremely high-temperature outside hearing environment.

The present invention is proposed in view of the above-described problems, and an object thereof is to provide a battery insulation structure that can be adapted to both a very low-temperature external environment and a very high-temperature external environment, and can reduce the influence of the temperature of the external environment on the batter as much as possible.

### Solution to Problem

A battery insulation structure of the present invention includes: a double-walled insulating container including an insulating container main body in which an insulating space is provided between an inner wall and an outer wall, and an insulating lid in which an insulating space is provided between an inner lid and an outer lid; and a battery body housed in the insulating container, wherein the battery body is arranged to be spaced apart from the inner wall of the insulating container main body and the inner lid of the insulating lid.

According to this configuration, heat conduction with the outside can be reduced in the insulating space of the double wall of the insulating container main body and the insulating space of the double wall of the insulating lid, and the heat conduction can be reduced in the air layer between the inner wall and the inner lid of the insulating container and the battery body. Thus, the heat conduction can be reduced doubly. Therefore, it is possible to be adapted to both a very low-temperature outside hearing environment and a very high-temperature outside hearing environment, and reduce the influence of the temperature of the external environment on the batter as much as possible. In other words, it is possible to prevent a temporary deterioration of the battery performance such as a decrease in the output voltage of the battery and a decrease in the discharge capacity, which occur in a low-temperature external environment. Moreover, it is possible to prevent a permanent deterioration of the battery performance and shortening of the battery life, which occur in a high-temperature external environment. Further, when the battery body is equipped with a protection circuit that regulates the output at a very high temperature, it is possible to prevent the protection circuit from operating unexpectedly at a very high temperature in the summer or the like.

In the battery insulation structure of the present invention, the insulating space of the insulating container main body and the insulating space of the insulating lid are decompression spaces.

According to this configuration, when the insulating spaces of the insulating container main body and the insulating lid are decompression spaces, the heat conduction between the external environment and the battery body can be further reduced, and the influence of the temperature of the external environment with respect to the battery can be further reduced.

In the battery insulation structure of the present invention, the battery body is installed with an insulating material fixed to the inner wall of the insulating container main body interposed therebetween.

According to this configuration, when the battery body is installed with the insulating material interposed therebetween, heat conduction from the inner wall of the insulating container main body at the support position of the battery body is reduced as much as possible, and the heat conduction between the insulating container main body and the battery body through the support position of the battery body can be suppressed as much as possible.

In the battery insulation structure of the present invention, a container-side flat flange is formed at an upper end of a peripheral side portion of the insulating container main body so as to protrude outward, a lid-side flat flange is formed on a peripheral edge of the insulating lid, and the insulating container is closed by placing the lid side flat flange on the container-side flat flange so that the insulating lid engages with the insulating container main body.

According to this configuration, when the insulating container is closed by placing the lid-side flat flange on the container-side flat flange so that the insulating lid engages with the insulating container main body, the insulating container can be closed by increasing the mutual contact area at the contact position of the insulating container main body and the insulating lid, and the airtightness, the sealing property, and the insulating property at the contact position between the insulating container main body and the insulating lid can be improved.

In the battery insulation structure of the present invention, the battery body has a heat exchange panel through which a heat exchange fluid circulates, and a fluid supply pipe for supplying the heat exchange fluid to the heat exchange panel and a fluid discharge pipe for discharging the heat exchange fluid from the heat exchange panel are provided so as to penetrate the double wall of the insulating container.

According to this configuration, for example, when the amount of heat generated by the battery body is large and the temperature is high, the heat can be collected via the heat exchange panel and the heat exchange fluid, the temperature of the inside of the insulating container or the battery body can be reduced, and permanent deterioration of the battery performance and shortening of the battery life can be prevented. That is, the temperature of the inside of the insulating container or the battery body can be adjusted to an appropriate temperature range and maintained in an appropriate temperature range.

In the battery insulation structure of the present invention, around a penetrating portion of the double wall of the insulation container through which a pipe or a cable is passed, a substantially concave cap is fixed to an outer surface of the insulating container with a concave side facing the outer surface of the insulating container, the pipe or the cable is inserted into an insertion hole formed in the substantially concave cap, and an insulating space is provided on the concave side of the cap.

According to this configuration, it is possible to suppress heat leakage around the penetrating portion of the double wall of the insulating container through which the pipe or the cable is passed, and to secure the heat insulation.

### Advantageous Effects of Invention

According to the battery insulation structure of the present invention, it is possible to be adapted to both a very low-temperature outside hearing environment and a very high-temperature outside hearing environment, and reduce the influence of the temperature of the external environment on the batter as much as possible.

### BRIEF DESCRIPTION OF DRAWINGS

FIG. 1 is a plan view of a battery insulation structure according to an embodiment of the present invention.

FIG. 2 is an enlarged cross-sectional view taken along the line A-A in FIG. 1.

FIG. 3 is an enlarged view taken along the line B-B in FIG. 2.

FIG. 4 is an enlarged view of the part C in FIG. 3.

### DESCRIPTION OF EMBODIMENTS

[Battery Insulation Structure of Embodiment]

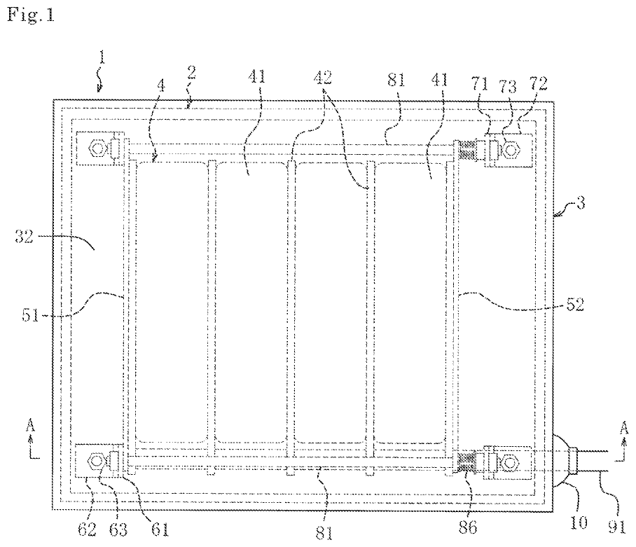

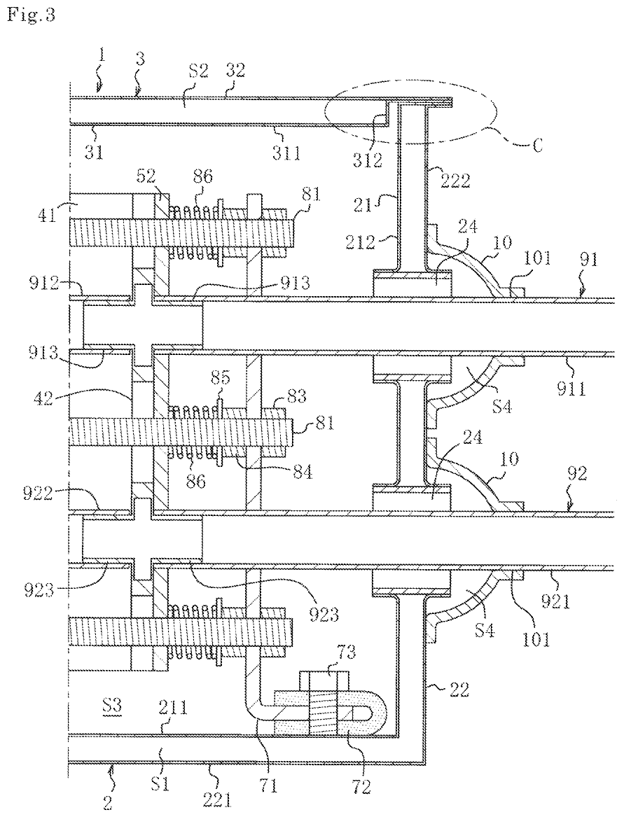

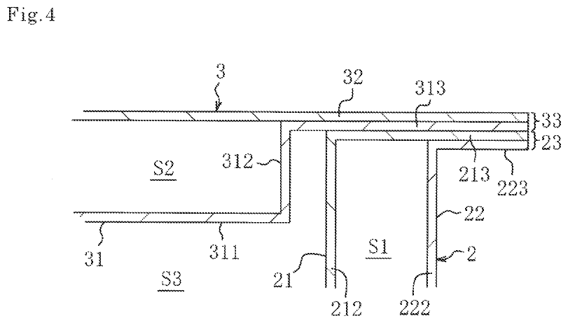

As shown in FIGS. 1 to 4, the battery insulation structure of an embodiment according to the present invention includes a double-walled insulating container 1 composed of an insulating container main body 2 and an insulating lid 3, and a battery body 4 housed in the insulating container 1.

The insulating container main body 2 is formed in a substantially rectangular box shape with an open upper surface, and has a double-wall structure including a substantially rectangular box-shaped inner wall 21 with an open upper surface and a substantially rectangular box-shaped outer wall 22 with an open upper surface. A bottom portion 211 of the inner wall 21 and a bottom portion 221 of the outer wall 22, and a peripheral side portion 212 of the inner wall 21 and a peripheral side portion 222 of the outer wall 22 are arranged to be spaced apart from each other, and an insulating space S1 is provided between the inner wall 21 and the outer wall 22. The insulating space S1 is preferably a vacuumed decompression space, but it can also be an air layer, and the insulating space S1 of the present embodiment is hollow but a solid insulating material may be filled in the insulating space S1.

A flat flange 213 protruding outward is formed at the upper end of the peripheral side portion 212 of the inner wall 21, and a flat flange 223 protruding outward is formed at the upper end of the peripheral side portion 22 of the outer wall 22. The flange 213 is overlapped so as to be placed on the flange 223, the ends of the inner wall 21 and the outer wall 22 are sealed, and the flanges are fixed by welding or the like at the overlapping position, whereby a container-side flat flange 23 is formed. That is, the container-side flat flange 23 protruding outward is formed at the upper end of the peripheral side portion of the insulating container main body 2.

The insulating lid 3 is formed in a substantially flat plate shape, and has a double-wall structure including a thin dish-shaped inner lid 31 whose center is recessed from the peripheral edge and a flat plate-shaped outer lid 32. The inner lid 31 has a substrate 311 and an erected portion 312 that stands around the substrate 311 and a flange 313 that protrudes outward from the upper end of the erected portion 312. The substrate 311 of the inner lid 31 and the outer lid 32 are arranged to be spaced apart from each other, and an insulating space S2 is provided between the substrate 311 of the inner lid 31 and the outer lid 32, in other words, between the inner lid 31 and the outer lid 32. The insulating space S2 is also preferably a vacuumed decompression space, but it can also be an air layer, and the insulating space S2 of the present embodiment is hollow but a solid insulating material may be filled in the insulating space S2.

The outer lid 32 is overlapped so as to be placed on the flange 313 of the inner lid 31. The ends of the inner lid 31 and the outer lid 32 are sealed, and the lids are fixed by welding or the like at the position where the outer lid 32 is overlapped with the flange 313 of the inner lid 31, whereby a lid-side flat flange 33 is formed. That is, the lid-side flat flange 33 is formed on the peripheral edge of the insulating lid 3.

The insulating container 1 is closed in such a way that a lower surface of the lid-side flat flange 33 having a planar area equal to or larger than the container-side flat flange 23 of the insulating lid 3 is overlapped so as to be placed on an upper surface of the container-side flat flange 23 having a planar area larger than the planar area at the upper end position of the insulating space S1 of the insulating container main body 2 and the insulating lid 3 engages with the insulating container main body 2. The container-side flat flange 23 and the lid-side flat flange 33, which are overlapped in a state where the planar contact area is larger than the planar area at the upper end position of the insulating space S1, are detachably fixed by fixing members such as bolts and nuts (not shown). It is also preferable to provide a sealing material between the container-side flat flange 23 and the lid-side flat flange 33, and to place the lid-side flat flange 33 on the container-side flat flange 23 via the sealing material interposed therebetween.

The outer peripheral dimensions of the substrate 311 and the erected portion 312 of the inner lid 31 of the insulating lid 3 are formed to be slightly smaller than the inner peripheral dimension at the upper end position of the inner wall 21 of the insulating container main body 2. In the closed state of the insulating container 1, the substrate 311 and the erected portion 312 of the inner lid 31 of the insulating lid 3 are tightly or loosely fitted inside the inner wall 21 of the insulating container main body 2, and the insulating lid 3 engages with the insulating container main body 2.

The battery body 4 has a plurality of battery cells 41 provided side by side at predetermined intervals, and heat exchange panels 42 provided on both sides of each battery cell 41 in the arrangement direction to circulate heat exchange fluid. The battery body 4 has a stacked structure in which the battery cell 41 and the heat exchange panel 42 are closely and alternately stacked. Holding plates 51 and 52 are provided on the outer sides of the heat exchange panels 42 and 42 located at both ends of the battery body 4 in the arrangement direction, and the battery cell 41 and the heat exchange panel 42, in other words, the battery body 4 is installed in the insulating container 1 so as to be sandwiched between the holding plates 51 and 52.

A side portion of a substantially L-shaped support stay 61 is arranged adjacent to the outer side of the holding plate 51 on one side in the arrangement direction of the battery cell 41 and the heat exchange panel 42, and the lower portion of the support stay 61 is engaged with an insulating material 62 such as an insulating rubber having a substantially U-shaped cross-section fixed to the bottom portion 211 of the inner wall 21 of the insulating container main body 2 and is fixed to the insulating material 62 by tightening a bolt 63. That is, the battery body 4 sandwiched between the holding plates 51 and 52 is installed with the insulating material 62 fixed to the inner wall 21 of the insulating container main body 2 interposed therebetween. The support stay 61, the insulating material 62, and the bolt 63 are arranged near both ends of the holding plate 51 on one side in a direction orthogonal to the arrangement direction of the battery cell 41 and the heat exchange panel 42 in the plan view of the insulating container 1.

A side portions of a substantially L-shaped support stay 71 is arranged at an interval from the holding plate 52 on the outer side of the holding plate 52 on the other side in the arrangement direction of the battery cell 41 and the heat exchange panel 42, and the lower portion of the support stay 71 is also engaged with an insulating material 72 such as an insulating rubber having a substantially U-shaped cross-section fixed to the bottom portion 211 of the inner wall 21 of the insulating container main body 2 and is fixed to the insulating material 72 by fastening a bolt 73. That is, the battery body 4 sandwiched between the holding plates 51 and 52 is installed with the insulating material 72 fixed to the inner wall 21 of the insulating container main body 2 interposed therebetween. The support stay 71, the insulating material 72, and the bolt 73 are arranged at positions corresponding to both ends of the holding plate 52 on the other side in a direction orthogonal to the arrangement direction of the battery cell 41 and the heat exchange panel 42 in the plan view of the insulating container 1.

A shaft bolt 81 is provided so as to penetrate the support stay 61, the holding plate 51, the holding plate 52, and the support stay 71. The shaft bolts 81 are provided on both sides of a direction orthogonal to the arrangement direction of the battery cell 41 and the heat exchange panel 42, and in the shown example, the shaft bolts 81 are provided at three locations in the upward and downward direction. A nut 82 is screwed into the shaft bolt 81 in close contact with the support stay 61 on the outer side of the support stay 61, a nut 83 is screwed in close contact with the support stay 71 on the outer side of the support stay 71, and a nut 84 is screwed in close contact with the support stay 71 on the inner side of the stay 71. A washer 85 is arranged on the holding plate 52 side of the nut 84.

A coil spring 86 is provided as an elastic material between the washer 85 and the holding plate 52, and the coil spring 86 is externally inserted to the outer periphery of the shaft bolt 81. The coil spring 86 presses and urges the holding plate 52 toward the holding plate 51 by elastic restoration, whereby the battery body 4 in which the battery cell 41 and the heat exchange panel 42 are closely and alternately stacked is sandwiched between the holding plate 51 and the holding plate 52 by the urging force. The battery body 4 supported by the urging of the coil spring 86 and the sandwiching of the holding plates 51 and 52 is arranged to be spaced apart from the inner wall 21 of the insulating container main body 2 and the inner lid 31 of the insulating lid 3, and an insulating space S3 is also formed inside the insulating container 1. The coil spring 86 also has a function of absorbing the expansion amount due to the thermal expansion by contraction deformation while maintaining the sandwiching state of the battery body 4 when the battery cell 41 thermally expands due to heat generation.

A fluid supply pipe 91 for supplying the heat exchange fluid to the heat exchange panel 42 and a fluid discharge pipe 92 for discharging the heat exchange fluid from the heat exchange panel 42 penetrate the double wall of the insulating container 1. In the present embodiment, the pipes are provided so as to penetrate the inner wall 21 and the outer wall 22 of the insulating container main body 2. The fluid supply pipe 91 includes a fluid introduction pipe 911, a connecting pipe 912 composed of an elastic tube such as a rubber tube that can be elastically restored and stretched, and a protruding pipe 913 that protrudes in the panel normal direction from the inlet port of the heat exchange panel 42. The fluid introduction pipe 911 is composed of an elastic tube such as a rubber tube that can be elastically restored and stretched, and is externally inserted and attached to the protruding pipe 913 of the heat exchange panel 42 that is arranged at the nearest position. The protruding pipes 913 and 913 of the heat exchange panels 42 and 42 arranged side by side are connected to each other via the connecting pipe 912, and both ends of the connecting pipe 912 are externally inserted and attached to the protruding pipe 913. The connecting pipe 912 composed of an elastic tube elastically expands to follow thermal expansion when the battery cell 41 thermally expands due to heat generation, and elastically restores according to the convergence of the thermal expansion to be adaptable to the thermal expansion.

The fluid discharge pipe 92 includes a fluid lead-out pipe 921, a connecting pipe 922 composed of an elastic tube such as a rubber tube that can be elastically restored and stretched, and a protruding pipe 923 that protrudes in the panel normal direction from the outlet port of the heat exchange panel 42. The fluid lead-out pipe 921 is also composed of an elastic tube such as a rubber tube that can be elastically restored and stretched, and is externally inserted and attached to the protruding pipe 923 of the heat exchange panel 42 that is arranged at the nearest position. The protruding pipes 923 and 923 of the heat exchange panels 42 and 42 arranged side by side are connected to each other via the connecting pipe 922, and both ends of the connecting pipe 922 are externally inserted and attached to the protruding pipe 923. The connecting pipe 922 composed of an elastic tube elastically expands to follow thermal expansion when the battery cell 41 thermally expands due to heat generation, and elastically restores according to the convergence of the thermal expansion to be adaptable to the thermal expansion.

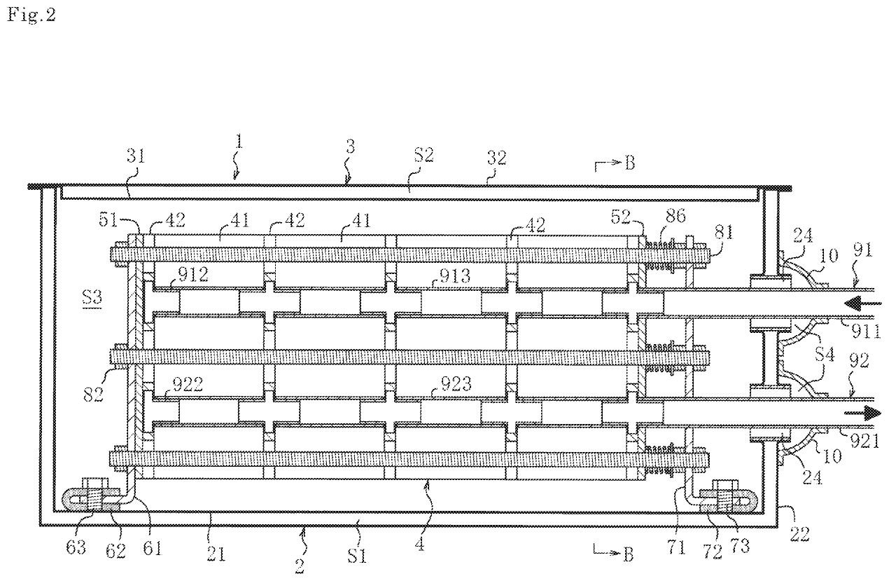

The heat exchange fluid such as cooling water supplied by the fluid supply pipe 91 is distributed to the respective heat exchange panels 42, enters from the inflow port, and flows through the respective heat exchange panels 42. The heat exchange fluid is then discharged from the outlet ports of the respective heat exchange panels 42 so as to be collected in the fluid discharge pipe 92, and is discharged to the outside through the fluid discharge pipe 92 (see the thick arrows in FIG. 2). The heat exchange panel 42 is provided with a partition for forming a flow path (not shown) therein, and a flow path through which the heat exchange fluid flows through substantially the entire interior of the heat exchange panel 42 is provided. Thus, the heat exchange between the heat exchange fluid flowing through the exchange panel 42 and the battery cell 41 is enhanced.

The insulating container main body 2 is provided with a penetrating portion 24 formed by fixing a short cylinder or the like so as to maintain a closed state of the insulating space S1 between the inner wall 21 and the outer wall 22. The penetrating portion 24 corresponds to the penetrating portion of the double wall of the insulating container 1. In the present embodiment, the fluid supply pipe 91 or the fluid introduction pipe 911 is provided through one penetrating portion 24, and the fluid discharge pipe 92 or the fluid lead-out pipe 921 is provided through the other penetrating portion 24. In this way, the fluid supply pipe 91 and the fluid discharge pipe 92 are connected to the inside and outside of the insulating container 1.

Around the penetrating portion 24, a substantially concave cap 10 is fixed to the outer surface of the insulating container 1 with the concave side facing the outer surface of the insulating container 1. In the present embodiment, the cap 10 is fixed by welding or the like to the outer surface of the outer wall 22 of the insulating container main body 2. An insertion hole 101 is formed substantially in the center of the cap 10, and the fluid introduction pipe 911 and the fluid lead-out pipe 921 are inserted into the insertion hole 101. An insulating space S4 surrounded by the cap 10, the outer surface of the outer wall 22, and the outer surface of the fluid introduction pipe 911 or the fluid lead-out pipe 921 is provided on the concave side of the substantially concave cap 10 (in the shown example, the bowl-shaped cap 10).

According to the battery insulation structure of the present embodiment, heat conduction with the outside can be reduced in the insulating space S1 of the double wall of the insulating container main body 2 and the insulating space S2 of the double wall of the insulating lid 3, and the heat conduction can be reduced in the air layer of the insulating space S3 between the inner wall 21 and the inner lid 31 of the insulating container 1 and the battery body 4. Thus, the heat conduction can be reduced doubly. Therefore, it is possible to be adapted to both a very low-temperature outside hearing environment and a very high-temperature outside hearing environment, and reduce the influence of the temperature of the external environment on the batter as much as possible. In other words, it is possible to prevent a temporary deterioration of the battery performance such as a decrease in the output voltage of the battery and a decrease in the discharge capacity, which occur in a low-temperature external environment. Moreover, it is possible to prevent a permanent deterioration of the battery performance and shortening of the battery life, which occur in a high-temperature external environment. Further, when the battery body 4 is equipped with a protection circuit that regulates the output at a very high temperature, it is possible to prevent the protection circuit from operating unexpectedly at a very high temperature in the summer.

Further, when the insulating spaces S1 and S2 of the insulating container main body 2 and the insulating lid 3 are decompression spaces, the heat conduction between the external environment and the battery body 4 can be further reduced, and the influence of the temperature of the external environment with respect to the battery can be further reduced.

When the battery body 4 is installed with the insulating materials 62 and 72 interposed therebetween, heat conduction from the inner wall 21 of the insulating container main body 2 at the support position of the battery body 4 is reduced as much as possible, and the heat conduction between the insulating container main body 2 and the battery body 4 through the support position of the battery body 4 can be suppressed as much as possible.

When the insulating container 1 is closed by placing the lid-side flat flange 33 on the container-side flat flange 23 so that the insulating lid 3 engages with the insulating container main body 2, the insulating container 1 can be closed by increasing the mutual contact area at the contact position of the insulating container main body 2 and the insulating lid 3, and the airtightness, the sealing property, and the insulating property at the contact position between the insulating container main body 2 and the insulating lid 3 can be improved.

Since the fluid supply pipe 91 for supplying the heat exchange fluid to the heat exchange panel 42 of the battery body 4 and the fluid discharge pipe 92 for discharging the heat exchange fluid from the heat exchange panel 42 are provided so as to penetrate the double wall of the insulating container 1, for example, when the amount of heat generated by the battery body 4 is large and the temperature is high, the heat can be collected via the heat exchange panel 42 and the heat exchange fluid, the temperature of the inside of the insulating container 1 or the battery body 4 can be reduced, and permanent deterioration of the battery performance and shortening of the battery life can be prevented. That is, the temperature of the inside of the insulating container 1 or the battery body 4 can be adjusted to an appropriate temperature range and maintained in an appropriate temperature range.

Further, since the cap 10 is fixed to the outer surface around the penetrating portion 24 of the double wall of the insulating container 1, heat leakage around the penetrating portion 24 provided through the fluid supply pipe 91 and the fluid discharge pipe 92 can be suppressed and heat insulation can be ensured.

[Scope of Inclusion of Invention Disclosed in Present Specification]

The invention disclosed in the present specification includes, in addition to the inventions listed as inventions and embodiments, those specified by changing the partial contents thereof to other contents disclosed in the present specification to an applicable extent, those specified by adding other contents disclosed in the present specification to these contents, or those specified by deleting these partial contents to the extent that a partial action and effect can be obtained and making them into a higher concept. The invention disclosed in the present specification also includes the following modifications and additional contents.

For example, in the shown example of the battery insulation structure of the above-described embodiment, a part of the bolts 63 and 73 constituting the support member of the battery body 4 penetrates the insulating materials 62 and 72 and comes into contact with the insulating container 1. However, it is more preferable that only the insulating materials such as the insulating materials 62 and 72 constituting the support member of the battery body 4 are in direct contact with the insulating container 1.

The shape and number of penetrating portions 24 provided in the double wall of the insulating container 1 with the insulating spaces S1 and S2 closed may be changed appropriately. For example, the penetrating portion 24 through which the battery cable is passed, the penetrating portion 24 through which the fluid supply pipe 91 is passed, and the penetrating portion 24 through which the fluid discharge pipe 92 is passed may be provided individually. Alternatively, both the battery cable and the fluid supply pipe 91 or the fluid discharge pipe 92 may be passed through one penetrating portion 24.

Any fluid other than the cooling water may be appropriately used as the heat exchange fluid of the present invention, and a low-temperature liquid or gas, a high-temperature liquid or gas, or both may be appropriately used as needed.

### INDUSTRIAL APPLICABILITY

The present invention can be used, for example, when suppressing a change in temperature of a battery of an electric vehicle or the like.

### REFERENCE SIGNS LIST

1: Insulating container
2: Insulating container main body
21: Inner wall
211: Bottom portion
212: Peripheral side portion
213: Flange
22: Outer wall
221: Bottom portion
222: Peripheral side portion
223: Flange
23: Container-side flat flange
24: Penetrating portion
3: Insulating lid
31: Inner lid
311: Substrate
312: Erected portion
313: Flange
32: Outer lid
33: Lid-side flat flange
4: Battery body
41: Battery cell
42: Heat exchange panel
51, 52: Holding plate
61, 71: Support stay
62, 72: Insulating material
63, 73: Bolt
81: Shaft bolt
82, 83, 84: Nut
85: Washer
86: Coil spring
91: Fluid supply pipe
911: Fluid lead-out pipe
912: Connecting pipe
913: Protruding pipe
92: Fluid discharge pipe
921: Fluid lead-out pipe
922: Connecting pipe
923: Protruding pipe
10: Cap
101: Insertion hole
S1, S2, S3, S4: Insulating space

1-6. (canceled)

7. A battery insulation structure comprising:
a double-walled insulating container including an insulating container main body in which an insulating space is provided between an inner wall and an outer wall, and an insulating lid in which an insulating space is provided between an inner lid and an outer lid; and
a battery body housed in the insulating container, wherein
the battery body is arranged to be spaced apart from the inner wall of the insulating container main body and the inner lid of the insulating lid.

8. The battery insulation structure according to claim 7, wherein
the insulating space of the insulating container main body and the insulating space of the insulating lid are decompression spaces.

9. The battery insulation structure according to claim 7, wherein
the battery body is installed with an insulating material fixed to the inner wall of the insulating container main body interposed therebetween.

10. The battery insulation structure according to claim 8, wherein
the battery body is installed with an insulating material fixed to the inner wall of the insulating container main body interposed therebetween.

11. The battery insulation structure according to claim 7, wherein
a container-side flat flange is formed at an upper end of a peripheral side portion of the insulating container main body so as to protrude outward,
a lid-side flat flange is formed on a peripheral edge of the insulating lid, and
the insulating container is closed by placing the lid side flat flange on the container-side flat flange so that the insulating lid engages with the insulating container main body.

12. The battery insulation structure according to claim 8, wherein
a container-side flat flange is formed at an upper end of a peripheral side portion of the insulating container main body so as to protrude outward,
a lid-side flat flange is formed on a peripheral edge of the insulating lid, and
the insulating container is closed by placing the lid side flat flange on the container-side flat flange so that the insulating lid engages with the insulating container main body.

13. The battery insulation structure according to claim 9, wherein
a container-side flat flange is formed at an upper end of a peripheral side portion of the insulating container main body so as to protrude outward,
a lid-side flat flange is formed on a peripheral edge of the insulating lid, and
the insulating container is closed by placing the lid side flat flange on the container-side flat flange so that the insulating lid engages with the insulating container main body.

14. The battery insulation structure according to claim 10, wherein
a container-side flat flange is formed at an upper end of a peripheral side portion of the insulating container main body so as to protrude outward,
a lid-side flat flange is formed on a peripheral edge of the insulating lid, and
the insulating container is closed by placing the lid side flat flange on the container-side flat flange so that the insulating lid engages with the insulating container main body.

15. The battery insulation structure according to claim 7, wherein
the battery body has a heat exchange panel through which a heat exchange fluid circulates, and
a fluid supply pipe for supplying the heat exchange fluid to the heat exchange panel and a fluid discharge pipe for discharging the heat exchange fluid from the heat exchange panel are provided so as to penetrate the double wall of the insulating container.

16. The battery insulation structure according to claim 8, wherein
the battery body has a heat exchange panel through which a heat exchange fluid circulates, and
a fluid supply pipe for supplying the heat exchange fluid to the heat exchange panel and a fluid discharge pipe for discharging the heat exchange fluid from the heat exchange panel are provided so as to penetrate the double wall of the insulating container.

17. The battery insulation structure according to claim 9, wherein
the battery body has a heat exchange panel through which a heat exchange fluid circulates, and
a fluid supply pipe for supplying the heat exchange fluid to the heat exchange panel and a fluid discharge pipe for discharging the heat exchange fluid from the heat exchange panel are provided so as to penetrate the double wall of the insulating container.

18. The battery insulation structure according to claim 10, wherein
the battery body has a heat exchange panel through which a heat exchange fluid circulates, and
a fluid supply pipe for supplying the heat exchange fluid to the heat exchange panel and a fluid discharge pipe for discharging the heat exchange fluid from the heat exchange panel are provided so as to penetrate the double wall of the insulating container.

19. The battery insulation structure according to claim 11, wherein
the battery body has a heat exchange panel through which a heat exchange fluid circulates, and
a fluid supply pipe for supplying the heat exchange fluid to the heat exchange panel and a fluid discharge pipe for discharging the heat exchange fluid from the heat exchange panel are provided so as to penetrate the double wall of the insulating container.

20. The battery insulation structure according to claim 12, wherein
the battery body has a heat exchange panel through which a heat exchange fluid circulates, and
a fluid supply pipe for supplying the heat exchange fluid to the heat exchange panel and a fluid discharge pipe for discharging the heat exchange fluid from the heat exchange panel are provided so as to penetrate the double wall of the insulating container.

21. The battery insulation structure according to claim 13, wherein
the battery body has a heat exchange panel through which a heat exchange fluid circulates, and
a fluid supply pipe for supplying the heat exchange fluid to the heat exchange panel and a fluid discharge pipe for discharging the heat exchange fluid from the heat exchange panel are provided so as to penetrate the double wall of the insulating container.

22. The battery insulation structure according to claim 14, wherein
the battery body has a heat exchange panel through which a heat exchange fluid circulates, and
a fluid supply pipe for supplying the heat exchange fluid to the heat exchange panel and a fluid discharge pipe for discharging the heat exchange fluid from the heat exchange panel are provided so as to penetrate the double wall of the insulating container.

23. The battery insulation structure according to claim 7, wherein
around a penetrating portion of the double wall of the insulation container through which a pipe or a cable is passed, a substantially concave cap is fixed to an outer surface of the insulating container with a concave side facing the outer surface of the insulating container,
the pipe or the cable is inserted into an insertion hole formed in the substantially concave cap, and
an insulating space is provided on the concave side of the cap.

24. The battery insulation structure according to claim 9, wherein
around a penetrating portion of the double wall of the insulation container through which a pipe or a cable is passed, a substantially concave cap is fixed to an outer surface of the insulating container with a concave side facing the outer surface of the insulating container,
the pipe or the cable is inserted into an insertion hole formed in the substantially concave cap, and
an insulating space is provided on the concave side of the cap.

25. The battery insulation structure according to claim 11, wherein
around a penetrating portion of the double wall of the insulation container through which a pipe or a cable is passed, a substantially concave cap is fixed to an outer surface of the insulating container with a concave side facing the outer surface of the insulating container,
the pipe or the cable is inserted into an insertion hole formed in the substantially concave cap, and
an insulating space is provided on the concave side of the cap.

26. The battery insulation structure according to claim 15, wherein
around a penetrating portion of the double wall of the insulation container through which a pipe or a cable is passed, a substantially concave cap is fixed to an outer surface of the insulating container with a concave side facing the outer surface of the insulating container,
the pipe or the cable is inserted into an insertion hole formed in the substantially concave cap, and
an insulating space is provided on the concave side of the cap.
